(19) United States
(12) Patent Application Publication
(10) Pub. No.: US 2026/0081130 A1
(43) Pub. Date: Mar. 19, 2026

(54) ION OPTICAL COMPONENT

(71) Applicant: Spectro Analytical Instruments GmbH, Kleve (DE)

(72) Inventors: Volker HAMELBECK, Kleve (DE); Dirk ARDELT, Krefeld (DE); Rainer GROTE, Bedburg-Hau (DE)

(21) Appl. No.: 19/331,549

(22) Filed: Sep. 17, 2025

(30) Foreign Application Priority Data
Sep. 17, 2024 (DE) 10 2024 126 836.0

(51) Int. Cl. H01J 49/06; H01J 49/40

(52) U.S. Cl. CPC H01J 49/062; H01J 49/403

(57) ABSTRACT

An ion optical component includes at least one electrode assembly including a circular segment-shaped inner electrode and a ring segment-shaped outer electrode surrounding the inner electrode along a circumference, and two circular segment-shaped plates surrounded on both sides by the inner electrode and circumferentially surrounded by the outer electrode and including a uniform ring-shaped gap between each of the plates and the outer electrode. The ion optical component includes two electrode assemblies, each of which extends over a sector with an angle of about φ/2, where 90°<φ<180°, and are positioned one behind the other in such a way that a trajectory of an ion beam through the ion optical component is S-shaped and focused in two spatial directions.

### CROSS REFERENCE TO RELATED APPLICATIONS

This application claims the benefit of priority to German Patent Application No. 10 2024 126 836.0 filed on Sep. 17, 2024. The entire contents of this application are hereby incorporated herein by reference.

### BACKGROUND OF THE INVENTION

### 1. Field of the Invention

The present invention relates to ion optical components, mass spectrometers each including such an ion optical component, and methods for separating neutral particles from beams from ion source assemblies with plasma excitation.

### 2. Description of the Related Art

Mass spectrometers are commonly used devices for sensitive and precise qualitative and quantitative analysis of a wide variety of samples in solid, liquid, or gaseous form. Mass spectrometric analysis is based on the generation of charged particles, ions, from the sample to be analyzed, as only these can be separated and detected in a mass spectrometer. The conversion of the usually neutral analysis sample into ions takes place in an ion source of the mass spectrometer, which usually consists of a sample feed system and the actual sample ionization unit. The ionization of the sample components is usually carried out by supplying energy, which, for example, vaporizes and atomizes sample components and finally ionizes them by removing one or more electrons.

Since mass spectrometers must operate in a high vacuum due to their design, transferring the sample to an internal (i.e., vacuum) ionization unit or “ion source” often poses a technical challenge. In this context, atmospheric ion sources have been developed in which the appropriate preparation (e.g., evaporation, atomization) and ionization of the sample components takes place outside the high vacuum of the mass spectrometer, and the ions, which are usually generated at elevated or atmospheric pressure, are only transferred into the high vacuum of the mass spectrometer after ionization, for example, by differentially pumped pressure reduction stages. Well-known examples of atmospheric ion sources are electrospray ionization (ESI), chemical ionization (CI), atmospheric pressure chemical ionization (APCI), or inductively coupled plasma mass spectrometry (ICP). An example of an ion source operated at elevated but not atmospheric pressure is a glow discharge (GD).

All atmospheric ion sources for mass spectrometry have in common that, in addition to the desired ions of the sample components, they usually generate large amounts of non-ionized material at the same time, e.g., high-energy photons, neutral atoms or molecules of the carrier gas or solvent, metastable neutral particles, and even small salt particles.

All of the non-ionized components mentioned above that escape from the ion source together with the analyte ions must be kept away from subsequent stages of the mass spectrometer due to their disruptive effect on its function. Possible disruptions include, for example, contamination of ion optical elements and resulting malfunction or even failure, negative effects of increased gas load on subsequent differential pumping stages or on special ion optical components, e.g., RF collision cells, up to the generation of unwanted ions from the interaction of metastable particles or energetic photons with ion optics and device components.

To avoid the difficulties described above, most mass spectrometers with ion sources operated at elevated or atmospheric pressure have a separation stage in which the ions required for mass spectrometric analysis are separated from all uncharged (e.g., non-ionic) components. The use of such a separation stage upstream of the actual mass spectrometer (and, if necessary, also upstream of other separation stages, e.g., de-clustering, collision, or reaction cells) ensures that only charged particles enter the actual mass spectrometric system.

Such ion-neutral particle separation stages normally use the deflection of charged particles in electric or (more rarely) magnetic fields. Neutral particles are not affected in their trajectory by these fields, thus allowing easy separation between charged and uncharged particles.

However, it should be noted that, in addition to the desired separation between charged and neutral particles, other, usually undesirable effects can occur, which can lead to relevant differences in the properties of the ion population before and after the ion-neutral separation stage. Common effects include changes in spatial distribution, species population distribution, including the formation of unwanted species, or changes in energy distribution, for example, due to an unwanted energetic (or other) filtering effect.

An additional difficulty arises from the fact that a neutral particle separation stage is usually arranged as one of the first elements of an ion optical system following an ion source operated at elevated or atmospheric pressure in order to achieve the desired separation of all products of the ion source that are not required for mass spectrometric analysis as early as possible.

Conventional atmospheric ion sources often achieve the extraction of the ions of interest (as mentioned above, often together with uncharged sample components or other degradation products) by means of (supersonic) expansion from the ionization plasma previously generated in the ion source under atmospheric or sub-atmospheric pressure. In this process, a quasi-charge-neutral portion of the plasma generated in the ion source, i.e., containing ions and electrons, is extracted. Due to the isentropic expansion resulting from the pressure difference between the ionization plasma and the first stage of the mass spectrometer through a typically conical nozzle with a small diameter, the energy of the plasma components, which was previously distributed thermally across all degrees of freedom, is quasi-completely transferred to the degree of translational freedom in the beam direction, while all other degrees of freedom of the extracted particles are “frozen.” In particular, the unfavorable (because it leads to undesirable, e.g., charge neutralizing collisions) relative motion of the particles with respect to each other is thus effectively prevented.

Due to the quasi-charge neutrality and efficient supersonic extraction, it is possible to transfer a high number density of the ions generated in the atmospheric ion source into the vacuum as a diluted and suitably hydrodynamically focused supersonic gas jet, whose flow velocity in the beam direction is the same for all components and is given by the expansion of the carrier gas (e.g., Ar). The kinetic energy of the beam components (analyte and interfering ions, electrons, neutral particles) is therefore mass-dependent (due to the same expansion velocity for all particles) and low, typically in the range of <1.5 eV in a typical vacuum interface for extraction from an atmospheric inductively coupled plasma (ICP) for Ar atoms, for example.

Due to the efficient supersonic extraction, a quasi-charge-neutral plasma gas beam of high number density (usual estimates are in the range of several 10E15 atoms/cm3) and high flow rate (typical estimates are in the range of several 10E18 atoms/s) enters the actual ion optics connected to the vacuum interface.

The first ion optical element, usually on an electrostatic basis (although the alternative use of magnetic fields is conceivable), typically serves to extract the ions from the plasma gas jet and to perform a certain amount of initial beam shaping (focusing). When the plasma beam, which is initially quasi-charge-neutral, passes through the first ion optical element, the appropriately selected polarity separates the usually positive ions of the plasma gas beam from negative particles, usually electrons. Only the ions are guided further into the next stages of the arrangement, as are the neutral particles, whose trajectories resulting from supersonic expansion are naturally not influenced by the electric or magnetic fields of the first ion optical element.

The overall high ion number densities and flux rates at low kinetic energies lead to significant beam expansion due to Coulomb repulsion and space charge effects, which can be counteracted by strong acceleration of the extracted ions (commonly in the keV range). However, the use of this solution for efficient beam guidance requires the use of a mass analyzer that can efficiently separate ions of the corresponding energy according to their mass-to-charge ratio (e.g., a sector field or time-of-flight mass spectrometer), since undesirable space charge effects would reappear if the ion beam energy were subsequently reduced (see, for example, the equation derived by Child and Langmuir for the maximum ion current density extractable from an ion source in the space charge-limited case (e.g., in P. Spädke, in B. Wolf (ed.), Handbook of Ion Sources, CRC Press Boca Raton, New York, London, Tokyo (1995)).

Well-known “low-energy mass spectrometers,” such as the quadrupole mass filter, which is attractive for many applications due to its size and favorable price/performance ratio, require significantly lower ion beam energies, typically in the range of a few eV, to efficiently separate the incoming ions according to their mass/charge ratio. The guidance of intense ion beams at low energies (<1000 eV) therefore requires a special design of all ion optical elements in order to perform this task efficiently. Two-dimensional (2D) focusing elements have proven to be particularly advantageous in this regard.

While 2D focusing can be easily achieved using ion optical components that are rotationally symmetric around the beam axis, the situation is fundamentally different for deflectors (and energy filters) based on sector fields. Simple cylindrical sectors focus only in one plane (“dispersion plane,” for example, horizontal) and are virtually field-free in the perpendicular (“vertical plane”). This often results in unfavorable defocusing in the vertical plane (expansion of the phase space of the ion beam) caused by space charge effects, especially at low beam energies, which leads to (sometimes considerable) beam intensity losses at subsequent apertures due to the vertical profile enlargement. Such an ion beam is generally more difficult to guide, focus, and process. Quadrupole mass filters in particular also have a spatially limited acceptance radius for the incoming ion beam, within which efficient separation of the ions according to their mass/charge ratio is possible.

In order to enable efficient phase space-preserving guidance of intense low-energy ion beams in sector fields, 2D-focusing ion optical elements, such as spherical or toroidal sectors with different sector angles, are known. Although the desired 2D focusing can be achieved in this way, their manufacture is complex and expensive (due to the high precision required in terms of shape, position, and surface finish).

When using deflecting ion optics to separate charged and neutral particles, the energy dependence of the ion trajectories in a deflecting field must also be taken into account. Simple deflection results in an energy-dependent splitting of the ion trajectories by the field (“energy dispersion”), which can separate portions of the original ion population in subsequent apertures. Particularly in the case of atmospheric ion sources with supersonic extraction, this leads to unwanted mass-dependent transmission into the actual mass spectrometer, namely because in isentropic supersonic expansion all particles are accelerated to the same velocity and thus their linear momentum and kinetic energy become mass-dependent.

An exemplary neutral particle separation stage is known from patent specification EP 1 116 258 B1.

### SUMMARY OF THE INVENTION

Example embodiments of the present invention specify an ion optical component to separate the neutral particles, which has as little influence as possible on the ions and, in particular, maintains the initial phase space volume of the ion beam coupled out of the atmospheric ion source via suitable focusing. Example embodiments of the present invention also specify an ion optical component to separate the neutral particles which can be easily manufactured and used on a large scale using conventional manufacturing processes.

Example embodiments of the present invention provide ion optical components, mass spectrometers with such ion optical components, and methods to separate neutral particles from beams from ion source assemblies with plasma excitation.

Accordingly, an ion optical component according to an example embodiment of the present invention includes at least one electrode assembly including a circular segment-shaped inner electrode and a ring segment-shaped outer electrode surrounding the inner electrode along a periphery, and two circular segment-shaped plates on both sides of the inner electrode and within the outer electrode and including a uniform ring-shaped gap between each of the plates and the outer electrode, wherein the ion optical component includes two electrode assemblies, each of which extends over a sector with an angle of about φ/2, where 90°<φ &<180°, and are positioned one behind the other in such a way that a trajectory of an ion beam through the ion optical component is S-shaped and focused in two spatial directions.

The S-shape is preferably selected such that the incident beam and the outgoing ion beam preferably extend parallel or substantially parallel to each other with an offset that is large enough to reliably separate the neutral particles passing unhindered through the ion optical component from the outgoing ion beam.

The advantage of the ion optical component is its particularly simple mechanical design. At the same time, efficient (e.g., with good transmission) beam guidance of a non-ideal beam (e.g., divergent, broad(er) energy distribution, neutral particles, and residual gas) of charged particles is possible even in poor vacuum conditions. The beam can be guided at the lowest possible electrode voltages (risk of breakdown in poor vacuum). Another advantage is that the number of different electrodes/electrode potentials is kept to a minimum. The inner electrodes are preferably at the same potential. The outer electrodes are also preferably at the same potential. The ion optical component enables the separation of neutral and charged particles while compensating for dispersion effects in direction-influencing electric or magnetic fields (2D focusing). The separation of neutral particles takes place without interaction with electric field plates (avoiding the formation of surface contamination, which leads to field distortions and charging effects and thus instabilities, as well as increased service requirements).

To improve beam guidance, an intermediate baffle is preferably located between the two electrode assemblies.

The ion optical component can be particularly compact and have a depth (in a direction of propagation) in a range between about 70 mm and about 80 mm, for example.

Preferably, the two electrode assemblies are configured such that an offset between an incident ion beam and an outgoing ion beam is in a range between about 25 mm and about 50 mm, preferably at about 30 mm, for example.

The ion optical component is particularly compact, while at the same time providing effective separation, when φ/2 is equal to about 60°+/−5°, for example.

In an example embodiment, the outer electrodes are slotted along the circumference so that the neutral particles can escape unimpeded.

To reduce costs, it is advantageous if the two electrode assemblies are identical.

For use in a mass spectrometer, it is particularly advantageous if an input focus and an output focus of the beam are located outside the two electrode assemblies.

In addition, a mass spectrometer with a previously described ion optical component is provided, wherein the ion beams originate from a source assembly with plasma excitation, and the ion optical component is upstream of the analysis of the ion beam. Preferably, the ion optical component is located in a pumping stage to generate the vacuum required for the analysis of the ion beams.

The arrangement is particularly advantageous when the kinetic energy of the beam components imparted by supersonic expansion is low, typically in a range of about <1.5 eV in a typical vacuum interface for extraction from an atmospheric inductively coupled plasma (ICP) for Ar atoms, for example.

Preferably, the plasma gas beam has a high number density (typical estimates are in a range of approximately several 10E15 atoms/cm3) and a high flux rate (typical estimates are in a range of approximately several 10E18 atoms/s) in the actual ion optics connected to the vacuum interface, for example.

It is also advantageous if the mass spectrometer includes an impact plate onto which the neutral particles of the ion beam, which are not influenced by the ion optical component, strike in order to be deflected preferably in a targeted manner toward a downstream vacuum pump.

The mass spectrometer is preferably an inductively coupled plasma (ICP) mass spectrometer, a glow discharge mass spectrometer (GD-MS), or an electrospray ionization (ESI) mass spectrometer.

In addition, a method to separate neutral particles from a beam from an ion source assembly with plasma excitation is provided, and includes deflecting the beam via an ion optical component in such a way that an outgoing beam is offset (parallel or substantially parallel) to an incident beam perpendicular or substantially perpendicular to a direction of propagation of the incident beam (parallel or substantially parallel), the offset being such that the neutral particles unaffected by the ion optical component are spatially separated from the ions in the outgoing beam.

This results in the above-mentioned advantages. The ion optical component can be configured as described above.

Preferably, the beam is focused in the ion optical component in two spatial directions perpendicular or substantially perpendicular to the direction of propagation of the incident beam with mass-dependent energy distribution (2D focusing).

Furthermore, it is possible to correct deviations from ideal trajectories in real setups by suitably selecting electrostatic potential differences between an inner and outer electrode of the ion optical component.

In addition, a correction of the beam position (center position of the beam) can be achieved for spatially extended beams via additional potential differences on the field electrodes.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present invention are described in more detail below with reference to the drawings. Identical components or components with identical functions are assigned identical reference numbers in the drawings described in the following.

FIG. 1 shows a schematic representation of the components of a mass spectrometer.

FIG. 2 shows a schematic representation of a simulated particle trajectory in an ion optics arrangement.

FIG. 3 shows a schematic illustration of an ion beam passing through two electrode assemblies with electrode surfaces.

FIG. 4 shows a cross-section and a side view of an electrode assembly.

### DETAILED DESCRIPTION OF THE EXAMPLE EMBODIMENTS

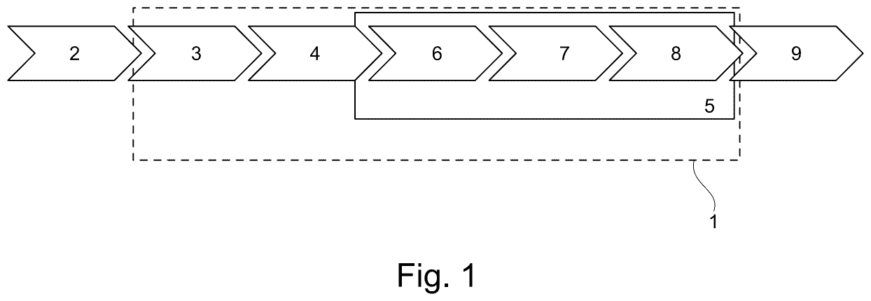

FIG. 1 shows the principle of a mass spectrometer 1 setup. A sample is fed into the device via an entry system 2 and conditioned if necessary. In the next step, depending on the type of sample and the selected method, the ions are generated, preferably from a source assembly with plasma excitation under atmospheric or (compared to atmospheric pressure) elevated pressure 3. A beam from an ion source assembly with plasma excitation is formed and focused via a first ion optic 4. The pressure reduction from the level of the ion source at elevated or atmospheric pressure to the pressure required for the operation of a mass spectrometric arrangement, usually in the high or ultra-high vacuum range in a vacuum chamber 5, takes place in several stages in differential pumping stages that are not shown. Depending on the installed pump power and the nozzle diameters used, the pressure in the first pumping stages is often still in the rough or fine vacuum range, and the beam trajectory of the particles expanded from the ion source is still strongly influenced by gas dynamic effects due to the relatively high number densities of the carrier or plasma gas on the beam axis as well as the relatively high background pressure and resulting interaction effects, e.g., residual gas collisions.

The separation 6 of residual neutral gas particles and photons in a separation stage preferably takes place in the first or one of the first pump stages before the actual analysis of the ion beam in order to improve the analysis result and avoid contamination of the downstream components. The separation 6 will be discussed in detail below. Finally, the ions pass through a mass filter 7 and are then registered in an ion detector 8. A data connection to a computing and controller 9 is used to control the measurement process and collect data.

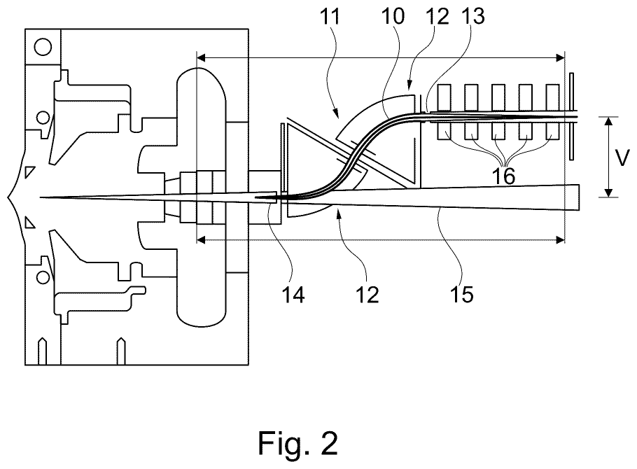

FIG. 2 shows a simulation of the beam 10 from an ion source assembly with plasma excitation as it passes through the separation stage 11. The separation stage 11 includes two electrode assemblies 12 of electrode surfaces that preferably have the same opening angle, for example. The trajectory of the transported beam 10 has an “S” shape. The separation stage 11 includes a cross-sectional geometry that rotates around an axis in one direction and around a second spatially offset parallel axis around which it rotates in the opposite direction.

The outgoing ion beam 13 is offset parallel or substantially parallel to the incident beam 14 by an offset v. The neutral particles 15 are not deflected and are thus spatially separated from the outgoing ion beam 13. Behind the separation stage 11, further lenses 16 are provided to focus the ion beam 13. An integrated baffle plate (not shown) serves to ballistically deflect the separated neutral particles 15 toward a downstream vacuum pump.

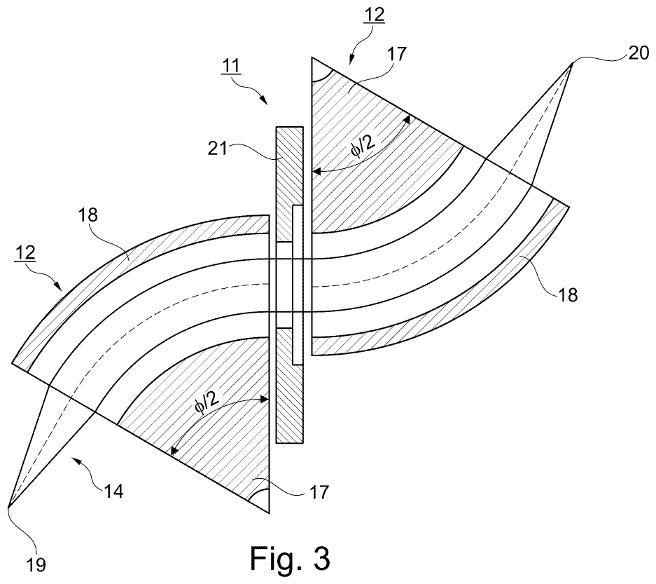

FIG. 3 shows the separation stage 11 with the two electrode assemblies 12 of electrode surfaces in detail. Within each electrode assembly 12, an electrostatic field distribution is generated in the space along the transported ion beam, which deflects the incident low-energy divergent beam 14 from an ion source assembly with plasma excitation in the front electrode assembly (in the direction of propagation) by half of the sum angle (φ/2) in a first direction and, in the rear geometrically identical electrode assembly in the same plane, by the same angle (φ/2) in the second opposite direction. For this purpose, the two electrode assemblies 12 each include an inner electrode 17 and an outer electrode 18, between which the beam is guided. The resulting trajectory has an “S” shape, which reduces or minimizes typical dispersion effects when deflecting in only one direction.

In the example shown φ/2=about 60°+/−5°, for example. The input focus 19 and output focus 20 of the optics are located outside the separation stage 11, which makes it easy to integrate them into the ion optics of a mass spectrometer. Other value ranges up to a total angle φ of about 180° are possible, for example.

In addition to beam offset, focusing in two spatial directions perpendicular to the direction of propagation is achieved by spherical field components over the mass range 6-254 amu with mass-dependent energy distribution.

An intermediate baffle 21 is provided between the two electrode assemblies 12 in the direction of propagation to reduce or minimize stray fields and electrical field divergences at the transition between the two electrode assemblies 12. The intermediate baffle 21 ensures electrical separation of the potentials and the associated ion optically consistent guidance of the beam.

The principle of beam offset is fundamentally applicable to ion beams from a source assembly with plasma excitation, such as in an inductively coupled plasma (ICP) mass spectrometer, glow discharge mass spectrometry (GD-MS), or mass spectrometry with electrospray ionization (ESI).

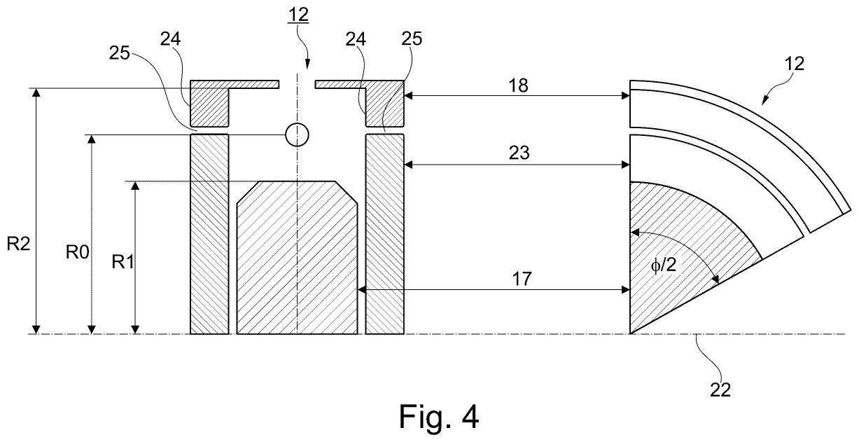

FIG. 4 shows in detail a single electrode assembly 12 in cross-sectional and side views with a jointly depicted axis of rotation 22.

The inner electrode 17 is circular segment-shaped with a radius R1 and extends over a sector (circular segment) with an angle φ/2, where 90°<φ<180°, for example. The inner electrode 17 includes two end surfaces that are parallel or substantially parallel to each other. The transition between the end surfaces and the edge is rounded. The end surfaces are covered by lateral circular segment-shaped plates 23, which have a radius R0, where R0 is greater than R1. The plates 23 extend over the same sector as the inner electrode 17. The outer electrode 18 also extends over the sector and is ring-shaped, with both ends bent inwards by 90° and each bend 24 lying in the same plane as the corresponding lateral plate 23, so that the side plate 23 faces with its front side toward the corresponding front side of the bend 24 and there is a uniform ring-shaped gap 25 between them. The outer electrode 18 thus has a substantially U-shaped cross-section. The inner diameter of the outer electrode 18 in the area between the bends 24 is R2. R2 is greater than R0. The outer electrode 18 is slotted in the circumferential direction in the area between the bends for efficient venting under vacuum conditions, so that the neutral particles can escape from the component in the direction of propagation and the pumping rate of untransported components of the beam is improved.

The center position of the beam 10 is centered between the electrodes 17, 18 at approximately a radius R0 and perpendicular to it, centered between the two side plates 23.

The inner and outer electrodes 17, 18 are shaped in such a way that the spherical field components are generated from mechanically simple geometries, i.e., by dispensing with precisely shaped spherical surfaces. The field plates 23, which can be contacted from the side, enable a space-saving design. By supplying them with a suitable electrostatic potential, they terminate the course of the internal field distribution and thus prevent distortions of the deflecting field as a result of field penetration from the outside. By appropriately selecting electrostatic potential differences between the inner and outer electrodes 17, 18, deviations from ideal trajectories in real structures can be corrected and, for example, mechanical imperfections or inaccuracies caused by wear can be remedied. Correction of the beam position (center position of the beam) for spatially extended beams is achieved by additional potential differences on the field electrodes. The inner and outer electrodes 17, 18 generally have approximately the same potential.

The separation stage preferably has a depth of about 70 mm to about 80 mm, for example. The beam offset is preferably at least about 25 mm and at most about 50 mm, in particular at about 30 mm, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ion optical component comprising:
at least one electrode assembly including a circular segment-shaped inner electrode and a ring segment-shaped outer electrode surrounding the inner electrode along a periphery, and two circular segment-shaped plates surrounded on both sides by the inner electrode and circumferentially surrounded by the outer electrode and including a uniform annular segment-shaped gap between each of the plates and the outer electrode; wherein
the ion optical component comprises two electrode assemblies each extending over a sector with an angle of about φ/2, where 90<φ<180°, and are positioned one behind the other in such a way that a trajectory of an ion beam through the ion optical component is S-shaped and focused in two spatial directions.

2. The ion optical component according to claim 1, wherein an intermediate baffle is located between the two electrode assemblies.

3. The ion optical component according to claim 1, wherein a depth of the ion optical component is in a range between about 70 mm and about 80 mm.

4. The ion optical component according to claim 1, wherein the two electrode assemblies are configured such that an offset between an incident ion beam and an outgoing ion beam is in a range between about 25 mm and about 50 mm.

5. The ion optical component according to claim 1, wherein φ/2 is equal to about 60°+/−5°.

6. The ion optical component according to claim 1, wherein the outer electrode is slotted along its circumference.

7. The ion optical component according to claim 1, wherein the two electrode assemblies are identical.

8. The ion optical component according to claim 1, wherein the two electrode assemblies are configured such that an input focus and an output focus of the beam are outside the two electrode assemblies.

9. A mass spectrometer comprising:
the ion optical component according to claim 1; and
a source assembly to provide ion beams with plasma excitation; wherein
the ion optical component is located upstream of a location of analysis of the ion beams.

10. The mass spectrometer according to claim 9, wherein the ion optical component is located in a pumping stage to generate a vacuum required to analyze the ion beams.

11. The mass spectrometer according to claim 9, further comprising an impact plate on which neutral particles of the ion beams unaffected by the ion optical component strike.

12. A method to separate neutral particles from a beam from an ion source assembly with plasma excitation, the method comprising:
deflecting the beam via the ion optical component according to claim 1 in such a way that an outgoing ion beam is offset from an incident beam perpendicular or substantially perpendicular to a direction of propagation of the incident beam, wherein the offset is such that neutral particles unaffected by the ion optical component are spatially separated from ions in an outgoing ion beam.

13. The method according to claim 12, wherein the beam is focused in the ion optical component in two spatial directions perpendicular or substantially perpendicular to the direction of propagation of the incident beam with mass-dependent energy distribution.

14. The method according to claim 12, wherein deviations from ideal trajectories in real setups are corrected by suitably selecting electrostatic potential differences between the inner electrode and the outer electrode of the ion optical component.

15. The method according to claim 12, wherein a correction of a beam position in spatially extended beams is achieved by additional potential differences between the inner electrode and the outer electrode.
